(19) United States
(12) Patent Application Publication
(10) Pub. No.: US 2019/0242173 A1
(43) Pub. Date: Aug. 8, 2019

(54) DOOR DRIVING MECHANISM FOR A SWING DOOR

(71) Applicant: ASSA ABLOY ENTRANCE SYSTEMS AB, Landskrona (SE)

(72) Inventor: Sven-Gunnar Soderqvist, Vallakra (SE)

(21) Appl. No.: 16/344,503

(22) PCT Filed: Nov. 17, 2017
(86) PCT No.: PCT/EP2017/079559

§ 371 Date: Apr. 24, 2019

(30) Foreign Application Priority Data
Nov. 21, 2016 (SE) 1630271-3

(51) Int. Cl. E05F 15/63; E05F 3/22

(52) U.S. Cl. CPC E05F 15/63; E05F 2015/631; E05F 2003/228; E05F 3/227

(57) ABSTRACT

A door driving mechanism for connecting a door operator (30) to a swing door leaf (14) is provided. The door driving mechanism comprises a guiding member (22) fixedly arranged to the door leaf (14); and a driving arm (24) at one end being rotationally driven by the door operator (30), wherein said driving arm (24) is slidably connected to the guiding member (22) at a fixed position in relation to the door leaf.

### TECHNICAL FIELD

The present invention relates to a door driving mechanism for moving a door leaf. More preferably the present invention relates to a door driving mechanism for automatic swing doors and a doors assembly having said door driving mechanism.

### BACKGROUND

The use of automatic opening and closing of swing doors is commonly known to facilitate entrance and exit to buildings, rooms and other areas. Proper functioning of such automatic opening and closing is particularly important for fire doors. Fire doors are often comparatively heavy in order to be able to sufficiently withstand fire and automatic operation, i.e. opening and/or closing is thus beneficial.

Automatic operation of swing doors is typically controlled by means of a door operator. The door operator is normally provided at the door frame and including an electrical motor being connected to the door leaf via some kind of transmission. The transmission is constructed to apply the required amount of torque to the door leaf. Importantly, this opening or closing torque must be very accurate and it must conform to certain standards, such as SS-EN 1154. According to this standard, the required torque is varying through the opening and closing action and is thus dependent on the angular position of the door leaf. As is evident from such requirements the transmission is rather complex. According to well-known prior art door operator transmissions accurate control of the operation torque can be achieved by providing the transmission with cam curves and dedicated springs.

Except for complex design, existing door operators also needs to be strong and large in size, especially for concealed applications of which the door operator needs to be arranged close to the pivot axis of the door leaf. It would therefore be beneficial to provide a solution allowing for a reduction of the size of the door operator while maintaining, or even increasing, the performance of prior art system.

### SUMMARY

An object of the present invention is therefore to provide a solution to the above-mentioned problem, reducing the disadvantages of prior art solutions.

An idea of the present invention is to provide a door driving mechanism for connecting a door operator to a door leaf. The door driving mechanism not only allows for concealed mounting of the door operator, which means that the door operator can be incorporated into the door frame, but also allows for a reduction of the complexity of the associated door operator.

According to a first aspect, a door driving mechanism for connecting a door operator to a swing door leaf is provided. The door driving mechanism comprises a guiding member fixedly arranged to the door leaf; and a driving arm at one end being rotationally driven by the door operator directly at said one rotationally driven end being the pivot point, wherein said driving arm is slidably connected to the guiding member at a fixed position in relation to the door leaf.

According to an embodiment the guiding member is arranged at the upper end of the door leaf and protrudes upwards from the door leaf. This allows the associated door operator to be concealed, i.e. incorporated into the upper part of the door frame.

The driving arm may comprise a track configured to receive the guiding member. This allows for a very simple and robust connection of the driving arm to the guiding member.

The track may be provided with horizontal shoulders for preventing vertical displacement of the guiding member relative the driving arm. Robust operation of the door driving mechanism is thereby ensured.

In an embodiment, rotation of the driving arm causes a longitudinal displacement of the guiding member relative the driven end of said driving arm. The door operator may thus be fixedly attached to the door frame, and the door operator may further be positioned at a distance from the pivot axis of the door leaf whereby a reduction gearing is effectuated.

According to a second aspect, a door operating system is provided. The door operating system comprises a door operator being fixedly attached to a door frame, a door leaf being pivotally connected to said door frame, and a door driving mechanism according to the first aspect connecting the door operator to said door leaf.

The driven end of the driving arm may be arranged at a first distance from the pivot axis of the door leaf, the guiding member may be arranged at a second distance from the pivot axis of the door leaf. The second distance may be greater than the first distance. Preferably, the first distance is between 200 and 220 mm, and the second distance is between 300 and 320 mm.

According to a third aspect, a method for providing a door driving mechanism for a swing door leaf is provided. The method comprises providing an upper end of the door lead with a guiding member, connecting a driving arm to a door operator, and slidably connecting the driving arm to the guiding member such that said driving arm (24) is slidably connected to the guiding member (22) at a fixed position in relation to the door leaf.

### BRIEF DESCRIPTION OF THE DRAWINGS

Embodiments of the invention will be described in the following; reference being made to the appended drawings which illustrate non-limiting examples of how the inventive concept can be reduced into practice.

FIG. 1 shows a side view of a door operating assembly according to an embodiment of the present invention;

FIG. 2 shows a schematic view of a door operator according to an embodiment of the present invention;

FIGS. 3a-c show schematic isometric views of a door driving mechanism according to an embodiment of the present invention;

FIG. 4 shows a schematic isometric view of a door operating assembly according to an embodiment of the present invention; and

FIG. 5 shows a schematic illustration of the characteristics of a door driving mechanism according to an embodiment of the present invention.

### DETAILED DESCRIPTION OF EMBODIMENTS

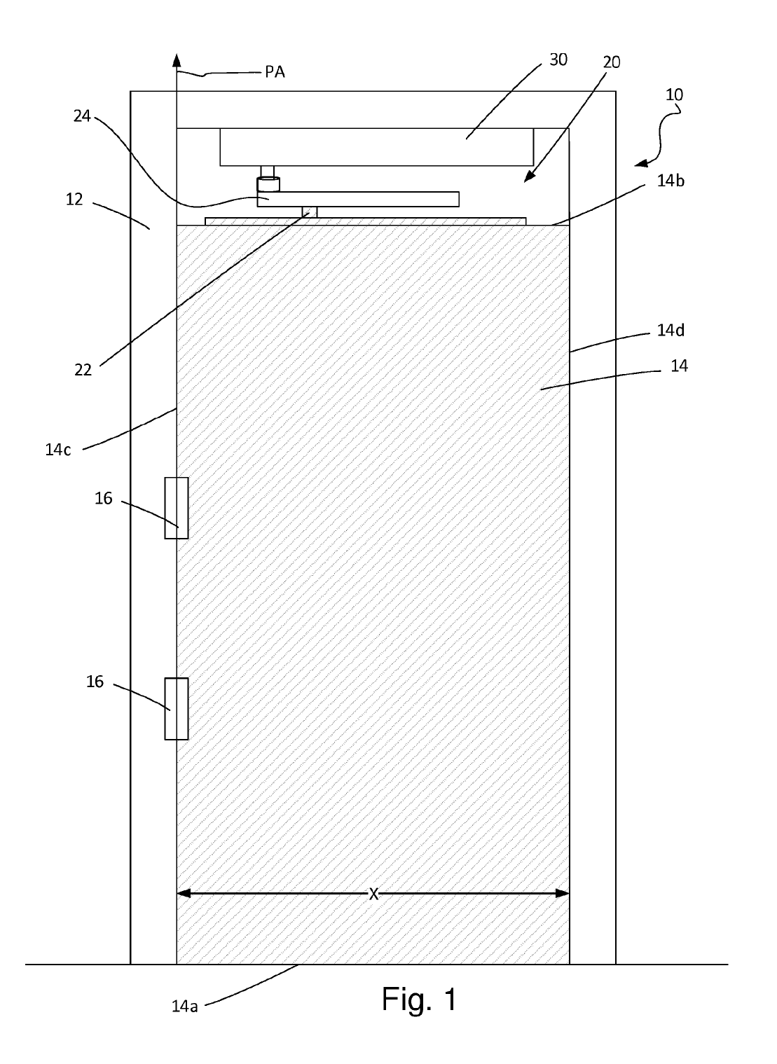

An example of a door driving mechanism will be described in the following. With reference to FIG. 1, a door operating assembly 10 including a door driving mechanism is shown. The door operating assembly 10 is in the form of a swing door assembly comprising a door leaf 14 rotationally supported by a door frame 12 by means of one or more hinges 16. The door leaf 14 may be a door constructed by wood, metal, plastic, glass or other suitable material. The door may also be a fire proof door having a fire resistant core made of various materials generally known in the art. Fire doors are arranged to stop or delay the transfer of thermal energy, i.e. heat, from one side of the door to another side and due to its construction these doors are often comparatively heavy.

The door leaf 14 is connected to the door frame 12 via the door hinges 16, whereby the door is pivotable. The door leaf 14 is thus movably arranged relative to the door frame 12 between an open position and a closed position. In FIG. 1, the lower part 14a of the door leaf 14 is facing the floor or ground, and the upper part 14b of the door leaf 14 is consequently opposite the lower part 14a and facing the ceiling. The left part 14c of the door leaf 14 is provided with hinges 16 and the right part 14d of the door leaf 14 is opposite the right part. The door leaf 14 has a width X and the door frame 12 is slightly wider in order to incorporate the full width of the door leaf 14 when closed. The door operating assembly 10 further comprises a door driving mechanism 20. Preferably, the door driving mechanism is a swing door driving mechanism 20. The door driving mechanism 20 described herein is suitable for various types of outwards and inwards swinging doors. The door driving mechanism 20 can e.g. be implemented at applications ranging from disabled person's access in private homes to high-traffic retail stores. It may also be used in different fire door applications. If the door driving mechanism 20 is used with a fire door, it is especially important that the door driving mechanism 20 is sufficiently strong in order to control the opening/closing of the heavy door.

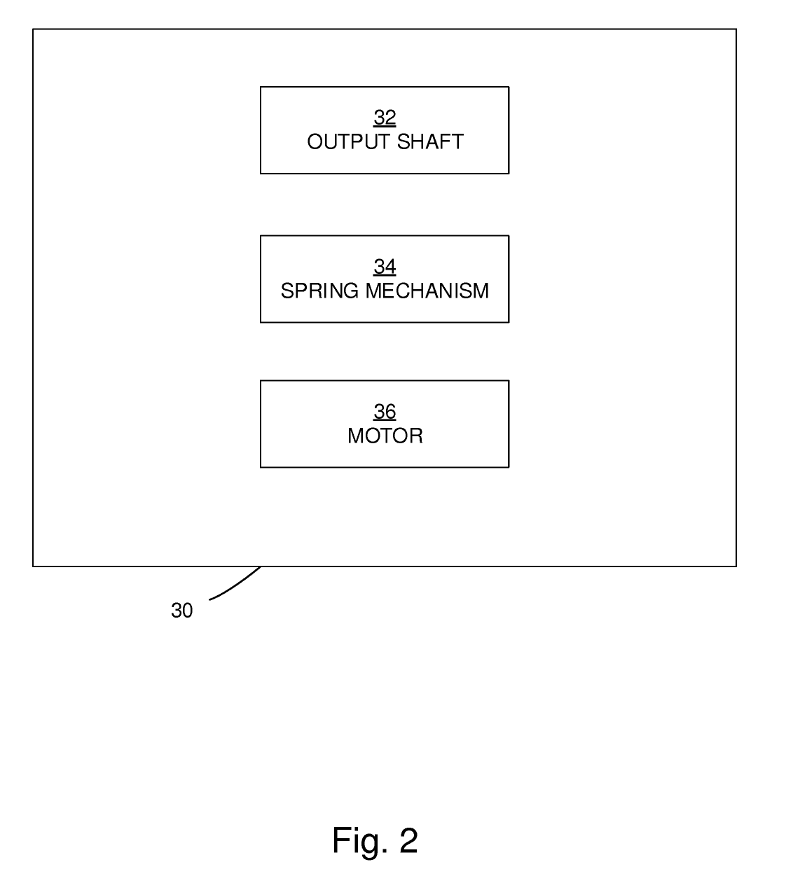

As seen in FIG. 1, the door driving mechanism 20 is associated with a door operator 30, a door driving arm 24 and a guiding member 22. The door operator 30 is configured to be able to automatically open and/or close the door leaf 14. The door operator 30 may be arranged in conjunction to the door frame 12, either on the sides or above the door leaf 14. Preferably, the door operator 30 is arranged as a concealed overhead installation in the door frame 12. The door operator 30, being schematically described in FIG. 2, may e.g. comprise an electrical motor 36 being connected to a transmission, whereby the transmission has an output shaft 32 which rotates upon activation of the electrical motor 36.

In prior art system, the door operators 30 normally comprises a helical compression spring 34 combined with a linkage system including a pressure roller that acts on a cam curve that is attached to an output shaft. During opening of the door, the compression spring is tensioned by the rotation of the output shaft. During the closing cycle, the accumulated spring force is transferred to the output shaft by means of the cam curve and the pressure roller and the transferred spring force is acting in the closing direction. The cam curve is preferably configured to provide the varying torque during the opening or closing sequence of the door leaf 14.

However, due to the inventive concept of having a fixed guiding member 22 in the door leaf 14 together with a door driving arm 24 being guided thereon, as will be further described herein, the need for a cam curve in the door operator 30 is eliminated.

In FIG. 2 the door operator 30 is shown, having a spring mechanism 34, an electrical motor 36 and an output shaft 32. The output shaft 32 is connected to the door driving arm 24 so as to allow the door leaf 14 to move. The spring mechanism 34 may e.g. be a clock spring or another type of leaf springs.

During opening of the door leaf 14, the spring 34 is tensioned by activation of the electrical motor 36 and a corresponding rotation of the output shaft 32. During the closing cycle, the accumulated spring force is transferred to the output shaft 32 and the transferred spring force is acting in the closing direction. It is possible to increase the closing force by using the motor 36 in combination with the spring and thereby increase the door closing force, a so called powered close.

The door operator 30, and thus the opening and/or closing of the door may e.g. be controlled by a button (not shown).

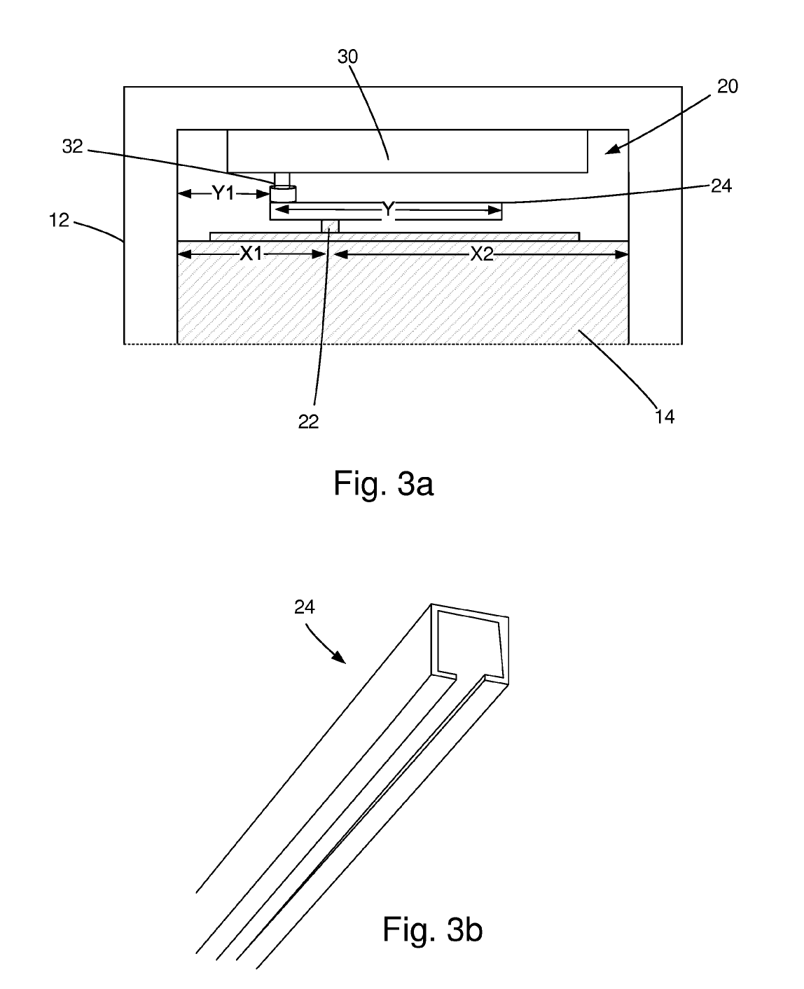

The door operator 30 is in operative connection with the driving arm 24, which will now be described further with reference to FIG. 3a-c. The door driving arm 24 is configured to open the door leaf 14 and/or close the door leaf 14. FIG. 3a, which is an enlargement of the door driving 20 of FIG. 1, illustrates that the door driving arm 24 is arranged adjacent to a surface of the door frame 12, preferably at the surface facing down towards the door leaf 14. The door driving arm 24 has a length Y. The length Y is preferably shorter than the width X of the door leaf 14. The door driving arm 24 is arranged at a distance Y1 from the pivot axis PA of the door leaf 14c. The distance Y1 may preferably be around 210 mm.

In one embodiment the door driving arm 24 is a sliding rail arm 24. An embodiment of the sliding rail arm 24 is shown in FIG. 3b. The sliding rail arm 24 is an elongated structure having a track 25 (see FIG. 3c) extending along is longitudinal axis. The sliding rail arm 24 may comprise horizontal shoulders 25a, 25b which are provided along the entire length of the sliding rail arm 24. The sliding rail arm 24 is preferably arranged such that the track 25 accommodates the guiding portion 22 arranged on the door leaf. The sliding rail arm 24 may be open at one or both ends. If one or both ends are open, they may be terminated by means of a respective end cap (not shown). Alternatively, the sliding rail arm 24 is closed at both ends.

Turning back to FIG. 1 and FIG. 3a, the guiding member 22 of the door driving mechanism will be described further. The guiding member 22 is fixedly attached to the upper part of the door leaf 14, protruding upwards and facing the door frame 12. The guiding member 22 is arranged at a distance X1 from the pivot axis PA of the door leaf 14c and at a distance X2 from the right end of the door leaf 14d, as is shown in FIG. 3a. The distance X1 may be smaller, larger or equal to the distance X2. The distance X1 is preferably around 310 mm. When the door leaf 14 is moved during opening/closing, the guiding member 22 maintains its fixed position in relation to the door leaf 14 to which it is attached.

The guiding member 22 may be a button-like structure protruding upwards from the door leaf 14. The guiding member 22 may have an exterior contour which fits the track 25 of the driving arm 24. The guiding member 22 may, at corresponding lateral surface facing the track 25 of the driving arm 24, have radial protrusions. This is shown in FIG. 3c, showing a cross section of the driving arm 24, including the shoulders 25a-b retaining the guiding member 22.

The guiding member 22 is arranged such that the driving arm 24 is guided along the guiding member 22 in a translational manner. The driving arm 24 is thus movable along the top surface of the door leaf 14 while the guiding member 22 is fixated in relation to the door leaf 14.

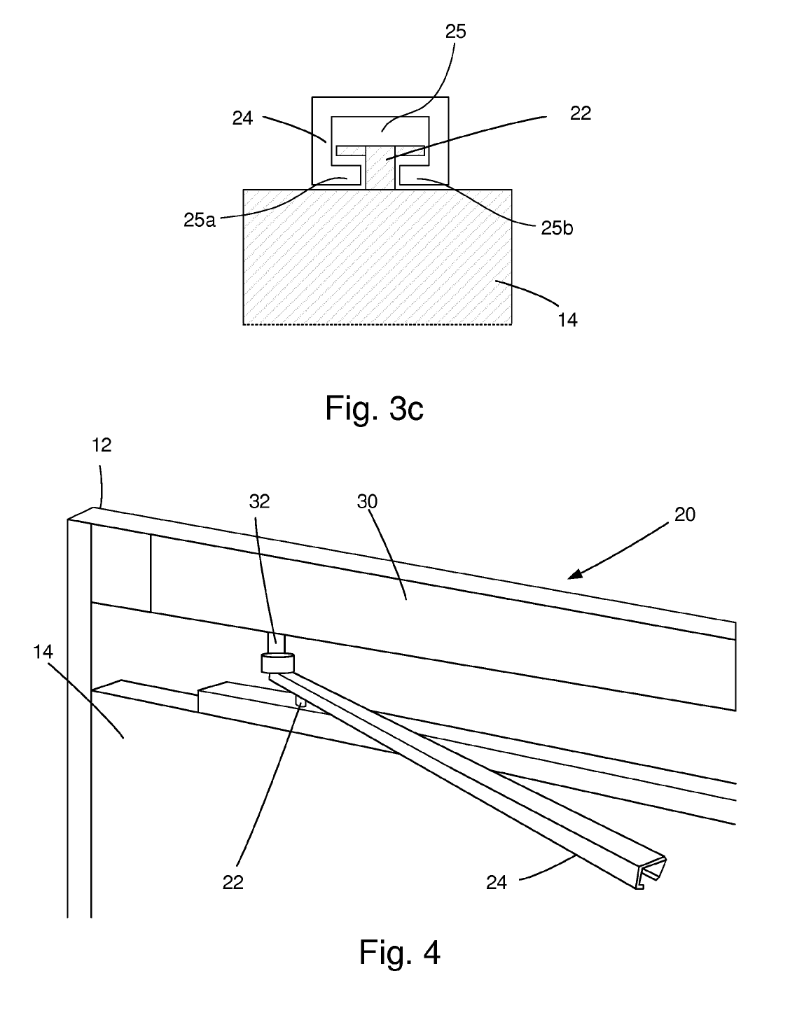

FIG. 4 illustrates a door leaf 14 being opened using the door driving mechanism 20 as described herein. The guiding member 22 is fixed relative the door leaf 14, and as the door leaf 14 opens the guiding member 22 will slide within the driving arm 24. The driving arm 24 is at one end connected to the output shaft 32 of the door operator 30. Since the driving arm 24 is operatively connected to the output shaft 32, which is connected to the electrical motor 36 of the door operator 20, the door will open. The door driving mechanism 20 thus acts through an off-set pivoting drive.

Hence, the driving arm 24 is at one end rotationally driven by the door operator 30. The driving arm 24 is driven directly at that end, which end can be seen as the pivot point generated by the rotation. In other words, the driving arm is directly, at one end, rotationally driven by the door operator 30 at the rotationally driven end. The inventive concept of having a fixated guiding member 22 in the door leaf 14 together with a sliding driving arm 24 has several benefits. First of all the arrangement makes the use of a cam in the door operator 30 unnecessary. Having a cam inside a door operator 30 is expensive due to its complex structure and it is thus beneficial to be able to remove the complexity will still being able to fulfill safety standards. For example, the safety standard BS EN 1154 relating to controlled door driving devices is fulfilled by the door driving mechanism 20 disclosed herein. Furthermore, having a sliding driving arm 24, attached to the door frame 12, arranged to be guided by a fixated guiding member 22 in the door leaf 14 creates an off-set driving. Since the system is not driving direct at the pivot axis PA of the door leaf 14, reduction outside the driving mechanism is achieved and the size of the driving mechanism can be reduced.

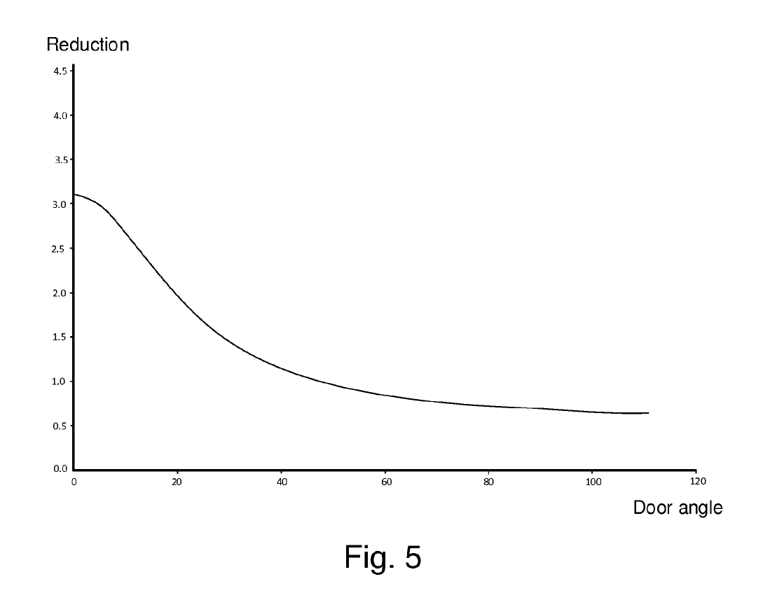

A schematic illustration of the characteristics of the door driving mechanism 20 is presented in FIG. 5. Reduction values are arranged on the y-axis and door angles are arranged on the x-axis, and the curve thus represents the reduction as a function of the door angle. As seen in the Figure, the maximum reduction, of approximate 3.10, is achieved for around 0° of door angle. Furthermore, the reduction of 2.00 is achieved at a door angle of 20°, a reduction of 1.50 is achieved at an approximate door angel of 30°, and reduction of 1.00 is achieved at an approximate door angel of 50°. For a door angle less than 110°, the reduction value is always above 0.5. For a door angle of approximately 105° the reduction value is approximately 0.6. Hence, the curve flattens with an increasing door angle. The reduction is constant where the guiding member 22 reaches the end of the driving arm, which occurs at an opening angle of approximately 60-80°. For smaller opening angles the reduction is decreasing continuously during an opening sequence from 0°. This characteristic provided by the door driving mechanism 20 thus fulfills the safety standard of BS EN 1154. The increased reduction at the initial opening angles ensures that the opening torque is sufficient, without requiring additional complex and expensive operators and drive units.

It should be appreciated that even though numerous characteristics and advantages of the present invention have been set forth in the foregoing description, together with details of the structure and function of the invention, the description is only illustrative and changes may be made in detail, especially in matters of shape, size and arrangement of parts within the scope of the invention to the full extent indicated by the appended claims.

1. A door driving mechanism for connecting a door operator (30) to a swing door leaf (14) comprising:
a guiding member (22) fixedly arranged to the door leaf (14); and
a driving arm (24) at one end being rotationally driven by the door operator (30) directly at said one rotationally driven end being the pivot point, wherein said driving arm (24) is slidably connected to the guiding member (22) at a fixed position in relation to the door leaf.

2. The door driving mechanism according to claim 1, wherein the guiding member (22) is arranged at the upper end of the door leaf (14) and protrudes upwards from the door leaf (14).

3. The door driving mechanism according to claim 1, wherein the driving arm (24) comprises a track (25) configured to receive the guiding member (22).

4. The door driving mechanism according to claim 3, wherein said track (25) is provided with horizontal shoulders (25a-b) for preventing vertical displacement of the guiding member (22) relative the driving arm (24).

5. The door driving mechanism according to claim 1, wherein rotation of the driving arm (24) causes a longitudinal displacement of the guiding member (22) relative the driven end of said driving arm (24).

6. The door driving mechanism according to claim 1, wherein the door driven mechanism (20) fulfills the safety standard BS EN1154.

7. The door driving mechanism according to claim 1, wherein the driving arm (24) and the guiding member (22) are arranged such that the reduction between the door operator (30) and the door leaf (14) is continuously decreasing from an initial opening angle of 0° to an intermediate opening angle where the guiding member (22) is arranged at the end of the driving arm (24).

8. The door driving mechanism according to claim 7, wherein the intermediate opening angle is between 60 and 80°.

9. The door driving mechanism according to claim 7, wherein the initial reduction, at the opening angle of 0°, is above 3.

10. A door operating system, comprising a door operator (30) being fixedly attached to a door frame (12), a door leaf (14) being pivotally connected to said door frame (12), and a door driving mechanism according claim 1 connecting the door operator (30) to said door leaf (14).

11. The door operating system according to claim 10, wherein the driven end of the driving arm (24) is arranged at a first distance (Y1) from the pivot axis (PA) of the door leaf (14), the guiding member (22) is arranged at a second distance (X1) from the pivot axis (PA) of the door leaf (14), and wherein the second distance (X1) is greater than the first distance (Y1).

12. The door operating system according to claim 11, wherein the first distance (Y1) is between 200 and 220 mm, and the second distance (X1) is between 300 and 320 mm.

13. A method for providing a door driving mechanism for a swing door leaf (14), comprising:
providing an upper end of the door lead (14) with a guiding member (22),
connecting a driving arm (24) to a door operator (30), and
slidably connecting the driving arm (24) to the guiding member (22) such that said driving arm (24) is slidably connected to the guiding member (22) at a fixed position in relation to the door leaf.
